(19) United States
(12) Patent Application Publication
(10) Pub. No.: US 2024/0265458 A1
(43) Pub. Date: Aug. 8, 2024

(54) METHOD AND SYSTEM FOR EXTRACTING INDICATIVE INFORMATION FROM PAST INVESTMENT PERFORMANCE

(71) Applicant: Chuan Wang, Kendall Park, NJ (US)

(72) Inventors: Andrew Ming Wang, Kendall Park, NJ (US); Daniel Chen Wang, Kendall Park, NJ (US); Chuan Wang, Kendall Park, NJ (US)

(21) Appl. No.: 18/619,145

(22) Filed: Mar. 27, 2024

(51) Int. Cl. G06Q 40/06

(52) U.S. Cl. CPC G06Q 40/06

(57) ABSTRACT

A method for extracting future performance indication from historical daily returns, instead of annual or monthly returns, by utilizing probability-weighted net-profit-to-loss ratio. It often begins with reorganizing raw results into individual daily returns. To simplify the calculations, the method avoids directly calculating with corresponding underlying probabilities. Instead, it reduces computing components of the ratio to straightforward sums of daily gains and losses that actually reflect the weighting effects by their underlying probability. Thus, future performance indication is extracted from the calculated ratio, determining if an investment strategy may statistically outperform a predetermined benchmark or generate positive net profits. The method's effectiveness is demonstrated using daily Russell-2000 index futures data over 2002-2022, where the exemplary strategy yielded superior positive net profits with reduced risks, substantially outperforming the market index benchmark in terms of risk-adjusted returns over 2002-2022.

### CROSS-REFERENCE TO RELATED APPLICATIONS

### Not Applicable

### FEDERAL SPONSORED RESEARCH

### Not Applicable

### INCORPORATION-BY-REFERENCE OF COMPUTER PROGRAM LISTING APPENDIX SUBMITTED

A Computer Program Listing Appendix is submitted to constitute a part of the specification of this invention, and are incorporated by reference herein for all purposes. The submitted computer program data are in the following computer file for carrying out embodiments of the invention. Table1.txt corresponds to a large computer data table that lists all the daily open and close prices of @RTY and daily rates of return resulted from both the benchmark strategy and the exemplary strategy. The data file was created in ASCII plain text in Feb. 27, 2024 and is 204 K-Bytes in size.

### BACKGROUND OF THE INVENTION

### A. Field of the Invention

This invention pertains to a method and system for evaluating performance of financial investment strategies, and/or resulted financial products, funds, or portfolios.

### B. Prior Art

Performance evaluation is a crucial process in the investment realm, as many investors believe that past successes may increase the likelihood of future ones. Among the various conventional performance measures, the Financial Industry Regulatory Authority (FINRA) suggests on its website, under the title of Investing Basics—Evaluating Performance, that the “annualized percent return” is the most effective method for comparing the performance of different investments. The annualized percent return is widely used due to its straightforward approach way of evaluating investments.

On the other hand, risk is another important factor that investors must evaluate. For instance, worst peak-to-valley drawdown is a critical risk measure that represents cumulative losses sustained by an account, and calculated on a compound monthly basis from the highest month-end to the lowest month-end.

Risk-adjusted return is another investment performance measure that considers the risk involved in attaining that return. This measure is typically expressed as a ratio between potential investment rewards and potential risks involved. Evaluating performance by using these measures allows investors to discern whether an investment's rewards are a result of strategic investing or excessive risk-taking, thus enabling informed decisions in line with their risk tolerance and investment objectives. Various risk-adjusted return measures exit and vary in how potential rewards and potential risks are formulated. For instance, the renowned Sharpe Ratio formulates the rate of actual return minus the risk-free rate as the numerator for potential rewards, and the standard deviation of individual rates of return as the denominator for potential risks.

Probability Theory is widely used in natural sciences and engineering. In natural sciences and engineering, to study uncertain phenomena, probabilities are often interpreted as limits of relative frequencies observed over large number of repeated experiments under the same conditions. In practice, probabilities or a probability distribution can be estimated from these observed relative frequencies. However, there is a limitation where if the number of repeat experiments is not sufficient, the relative frequencies observed may deviate from their true values. Such an objective interpretation of probability allows us to estimate it by observed relative frequencies, which can then be used to make useful predictions about future occurrences. Probability Theory has been pervasively used in natural sciences and engineering because it can describe and interpret most types of uncertain phenomena with useful predictions in the real world.

In the realm of investment, the prior art performance measures are only useful for evaluating past performance. They cannot extract any information that may be indicative for future or subsequent performance from past performance observed. Moreover, the annual and monthly rates of return that the regulators require for the registered investment managers to disclose are also not indicative of future performance. Therefore, there is a long-felt and unsolved need for “being able to extract indicative information from past results.”

### BRIEF SUMMARY OF THE INVENTION

The present invention discloses a method for evaluating if an investment method may statistically outperform a predetermined benchmark, or generate positive net profit with reduced risks statistically.

The present invention discloses a method to evaluate and optimize investment performance by introducing unique ratio of probability-weighted net profit to probability-weighted loss. This innovative concept distinguishes itself from conventional risk-adjusted return measures and enables the extraction of indicative performance information from historical results. The extracted indicative information can be used for evaluating if an investment method will likely or statistically outperform a predetermined benchmark, or generate positive net profit with reduced risks statistically.

The method comprises six major steps: (1) specifying the security to be traded by an investment strategy and benchmark for evaluation; (2) organizing, by dividing and/or combining, the original trading results into a sufficiently large data set; (3) computing all individual rates of return and related performance parameters; (4) calculating probability-weighted total-net-profit-to-total-losses ratio or probability-weighted average-net-profit-to-average-loss ratio from the calculated individual rates of return for both said investment strategy and said benchmark, respectively; (5) using calculated probability-weighted net-profit-to-loss ratio as future performance indication; and (6) accepting the investment strategy if the probability-weighted net-profit-to-loss ratio is significantly greater than the benchmark ratio.

By weighting the historical data with underlying probabilities, the ratio enables statistically informed evaluation of potential profits versus potential losses based on their relative likelihoods. Unlike conventional risk-adjusted return measures, this method considers probability-weighted characteristics in both the numerator and denominator of the ratios, reflecting frequencies determined by underlying probabilities. This feature is particularly valuable in investments, as frequency distributions of daily returns tend to remain stable over extended periods.

The method's effectiveness is illustrated through an embodiment involving continuous E-mini Russell-2000 futures, comparing an investment strategy to a Buy-and-Hold benchmark. The exemplary strategy's superior performance is attributed to its ability to generate substantially higher profit with substantially reduced risks, making it a more efficient investment strategy. Additionally, the invention provides a means for evaluating future performance based on past ratios of average net profit to average loss.

Overall, this invention offers a unique and statistically sound method for evaluating investment performance and optimizing investment strategies by leveraging probability-weighted ratios, ultimately leading to more informed investment decisions.

The method disclosed herein offers several advantages: (1) the developed method can be used to extract indicative performance information from past results, (2) the extracted indicative information can be used to evaluate if positive net profit with reduced risks can be statistically achieved, or (3) if outperforming a specified benchmark can be achieved statistically, and (4) the method can be used to guide investment managers to implement and optimize their investment.

### DESCRIPTION OF THE SEVERAL VIEWS OF THE DRAWING

FIG. 1 illustrates a flow chart diagram of a method that implements the present invention.

FIG. 2 shows the observed relative frequency distribution by the exemplary strategy compared with the benchmark Buy-and-Hold @RTY, a continuous Russell-2000 index futures.

FIG. 3 shows the probability weighted gains and losses by the exemplary strategy compared with the benchmark Buy-and-Hold @RTY, a continuous Russell-2000 index futures.

FIG. 4 shows the cumulative returns on a continuous future contract @RTY by the exemplary strategy and compared with the benchmark Buy-and-Hold of Russell-2000 index futures.

### DETAILED DESCRIPTION OF THE INVENTION

The present invention discloses a method for extracting future indication from a past investment performance by introducing an unconventional ratio of probability-weighted net profit to probability-weighted loss. It can be used for evaluating investment performance, and further optimizing an investment strategy. Different from conventional investment performance evaluation methods, such as risk-adjusted return measures, this probability-weighted ratio can be used to extract indicative information from the performance information observed in the past.

The method comprises six major steps: (1) specifying a security to be traded by an investment strategy and a predetermined benchmark for comparison; (2) organizing, by dividing and/or combining, the original trading results into a sufficiently large data set so that the organized results may provide future indication when becoming necessary; (3) computing all individual rates of return and related performance parameters; (4) calculating probability-weighted total-net-profit-to-total-losses ratio or probability-weighted average-net-profit-to-average-loss ratio from the calculated individual rates of return for both said investment strategy and said benchmark, respectively; (5) using calculated probability-weighted net-profit-to-loss ratio as future performance indication; and (6) accepting the investment strategy if the probability-weighted net-profit-to-loss ratio is significantly greater than the benchmark ratio. The word “statistically” used here means that after a substantially and sufficiently large number of individual trades, the total gains are significantly greater than the total losses within the meaning of Probability and Statistics. Systematic investment strategies are those rules-based having predetermined entry and exit conditions.

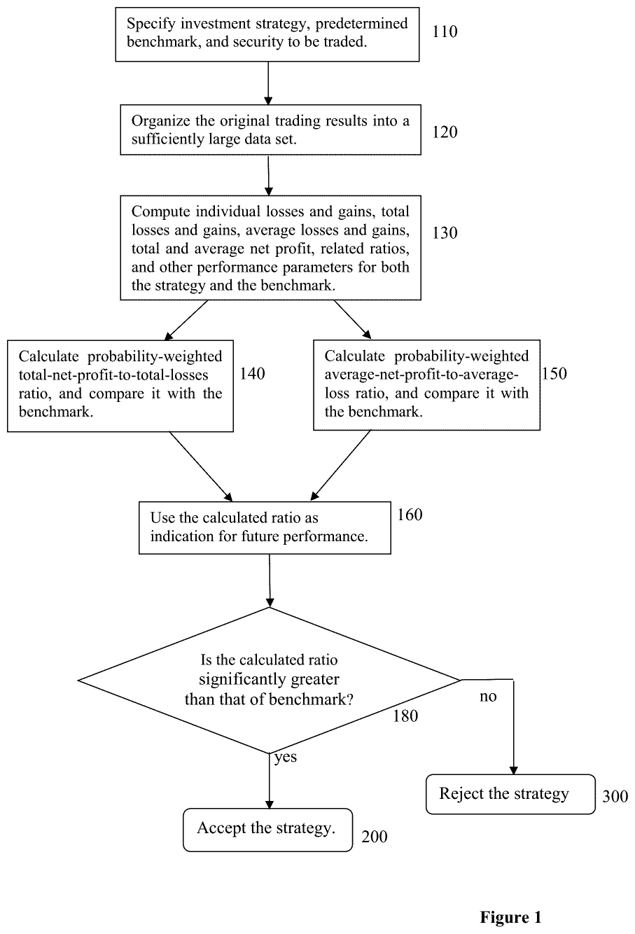

As shown in FIG. 1, this method may be implemented by using a computer in six major steps: (1) specifying a security to be traded by an investment strategy so that said investment strategy can be evaluated by comparing it with a predetermined benchmark, in Step 110; (2) in Step 120, organizing, by dividing and/or combining, the original trading results into a sufficiently large data set so that the organized results may provide future indication when becoming necessary; (3) computing all individual rates of return and relevant performance parameters, including individual losses and individual gains, total losses and total gains, average losses and average gains, total and average net profit, and related ratios in Step 130; (4) calculating probability-weighted total-net-profit-to-total-losses ratio or probability-weighted average-net-profit-to-average-loss ratio to extract indicative information from the calculated ratio, in Steps 140 or 150; (5) using calculated probability-weighted net-profit-to-loss ratio from the past individual results as future performance indication to determine if positive net profits with reduced risks can be achieved statistically, or if outperforming the specified benchmark can be achieved statistically, in Step 160; (6) accepting the calculated ratio as future performance indication for the strategy if the probability-weighted net-profit-to-loss ratio is significantly greater than the benchmark ratio in the Steps 180, 200, and 300.

In natural sciences and engineering, probability is often interpreted as a limit of observed relative frequency as the number of repeated experiments becomes very large. If the repeated experiments result in various values, they form a curve that describes the probability of different possible values. Such a curve is usually referred as a probability distribution. Probability may be comprehended to have predictive power because the future probability distribution is the same as the past one. In other words, one may comprehend that the relative frequency distribution observed in the past can be used to predict the relative frequency distribution in the future. Therefore, the overall future results can be approximately reproduced in a collective and statistical sense.

To introduce predictive characteristic, one may weight a parameter with its corresponding probability, thus calling it a probability-weighted parameter. A probability-weighted parameter can be calculated by multiplying the parameter by its corresponding probability. Consequently, like probability, a probability-weighted parameter has predictive power and is also expected within the meaning of Probability and Statistics. In other words, a probability-weighted parameter also has ability to predict its future values statistically from the observed values in the past. Within the meaning of Probability and Statistics, the word “statistically” used herein means overall and collectively, rather individually and precisely.

Different from conventional risk-adjusted return measures, both the numerator and denominator in the ratios of probability-weighted net profit to probability-weighted loss reflect frequencies which occurred according to the underlying probabilities. This characteristic is important in investment performance evaluation because relative frequency distribution of daily returns tends to be stable over a long period of time. Therefore, the ratio of probability-weighted net profit to probability-weighted loss is statistically predictive or expected within the meaning of Probability and Statistics.

### First Embodiment

To illustrate this embodiment, a continuous E-mini Russell-2000 futures offered by TradeStation Securities, Inc., (Symbol: @RTY) from 2002 to 2022 is used as an example. @RTY is a popular stock index futures contract, that tracks the Russell-2000 index, traded in a US futures market, the Chicago Mercantile Exchange, Inc. (CME).

The “Buy-and-Hold” @RTY is used as a benchmark. To evaluate its performance, consider a scenario where an @RTY contract is both sold and bought simultaneously at the daily stock market closing time. Since the @RTY is envisioned to be “sold” and “bought” at an identical price, this strategy essentially mimics the Buy-and-Hold approach with @RTY. The gains or losses for each hypothetical trade are represented as percentages by considering the changes in price relative to the previous day's closing price, devoid of any additional costs. Such hypothetical trade results offer a baseline for assessing general market behavior.

To allow statistically meaningful conclusions to be drawn, it sometimes becomes necessary to divide original trading results in order to satisfy the principle of large numbers in probability and statistics. In this illustration, the single 21-year trade is split into a larger sample size of 5,237 daily trades. Expanding the sample size in this manner enables scientifically valid analysis that achieves statistical significance.

In case more than one trades are made in a day, it may become necessary to combine the results of such multiple trades into daily results. The resultant performance can be then interpreted as expected results with statistical significance, but unlikely to have occurred solely due to luck. Overall, proper sample size consideration and framing of original results makes the observed performance outcomes more statistically meaningful.

In this illustration, @RTY is traded by an exemplary strategy. All the relevant data used herein, including entry and exit prices of @RTY and daily rates of return resulted from both the benchmark strategy and the exemplary strategy are listed in Table 1 named tablel.txt in the table appendix.

A rate of return is an important measure for investment performance, which, for a specific time period, is calculated as a percentage by dividing the price change between the exit and entry prices by the entry price. Rates of return for all individual trades, whether gain or loss, are calculated first. In this particular illustration, each individual trade resulted in a daily rate of return. Based on these daily rates of return, other relevant and conventional performance parameters of both the exemplary strategy and its benchmark Buy-and-Hold @RTY over the past 21 years can be calculated, and listed in Table 2 herein.

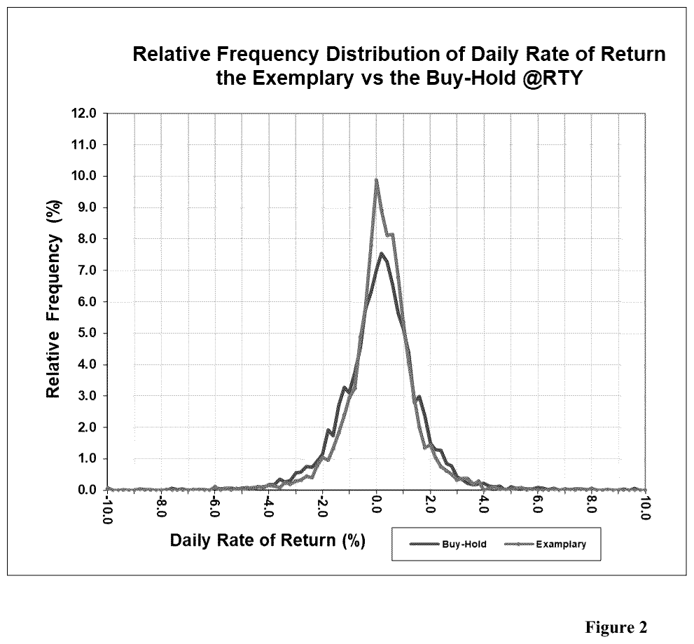

In practice, probabilities can be estimated from the observed relative frequencies of daily rates of return. The observed relative frequencies of the benchmark Buy-and-Hold @RTY and the exemplary strategy are plotted and shown in FIG. 2. Both curves are bell-shaped which generally require sufficiently large data set (thousands in this illustration) to form nicely. In contrast, a smaller data set will fail to form a reasonably bell-shaped relative frequency curve.

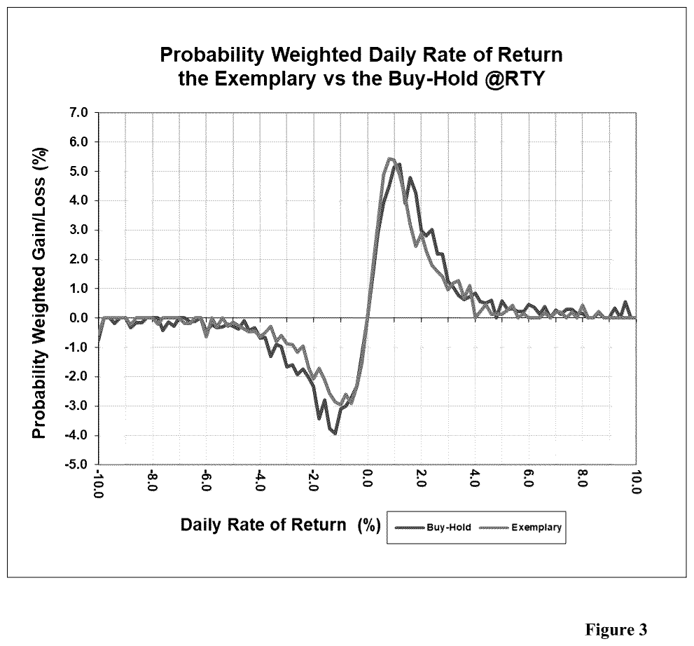

To extract indicative information from large number of historical rates of return, a concept of probability-weighted rates of return, whether gain or loss, is introduced herein. For each return interval along the horizontal axis, the gain or loss is multiplied by its corresponding observed relative frequency or the estimated probability as shown in FIG. 2, to estimate a probability-weighted gain or loss. The resulting probability-weighted gains and losses for both the Buy-and-Hold strategy and the exemplary strategy are depicted in FIG. 3.

As shown in FIG. 3, the area on the right side, beneath the probability-weighted gain curve and above the horizontal axis, represents the probability-weighted gains. Similarly, the area on the left side, above the probability-weighted loss curve and below the horizontal axis, represents the probability-weighted losses. The ratio of probability-weighted net profit to probability-weighted loss can be used to extract indicative information from large number of daily rates of return.

In practice, probability-weighted average loss can be estimated by dividing the experienced total daily losses by the total number of all trades, or all trading days in this illustration. Similarly, probability-weighted average gain can be estimated by dividing the experienced total daily gains by the total number of all trading days. Especially, probability-weighted average net profit can be estimated by dividing the total experienced net profit (total gains minus total losses) by the total number of all trading days. Therefore, ratio of average net profit to average loss may be used to estimate ratio of probability-weighted net profit to probability-weighted loss. The ratio of average net profit to average loss is thus further used for providing future performance insight.

As shown in Table 2, the average net profits of the Buy-and-Hold strategy and the exemplary strategy are 0.037% and 0.083%, respectively. The average losses of the Buy-and-Hold strategy and the exemplary strategy are −1.125% and −0.902%, respectively. As the results, the estimated ratios of probability-weighted average net profit to probability-weighted average loss for the Buy-and-Hold strategy and the exemplary strategy are 0.070:1 and 0.203:1, respectively.

For the exemplary strategy, one may comprehend its ratio of probability-weighted average net profit to probability-weighted average loss as follows: for every $0.203 gained, an investment would have to experience a loss of $1.00. In comparison, the benchmark Buy-and-Hold strategy gained $0.070 for each $1 loss experienced, meaning that by experiencing the same $1 loss, the exemplary strategy achieved 2.9 times as much net profit on average compared to that of the Buy-and-Hold strategy. Therefore, the exemplary strategy is much more efficient than the Buy-and-Hold strategy to generate profit.

TABLE 2
Results of Trading @RTY by the Buy-
and-Hold and Exemplary strategy (2002-2022)

| strategy | Buy-Hold | Exemplary |
|---|---|---|
| worst drawdown (%) | −57.2 | −25.9 |
| total compound return (%) | 258.4 | 1507.3 |
| average net profit (%) | 0.037 | 0.083 |
| average (daily) gain (%) | 0.561 | 0.491 |
| average (daily) loss (%) | −0.525 | −0.408 |
| standard deviation | 1.566 | 1.342 |
| total daily gains (%) | 2940.3 | 1844.6 |
| total daily losses (%) | −2748.1 | −1532.9 |
| total net profit (%) | 192.2 | 311.7 |
| max daily gain (%) | 9.6 | 15.1 |
| max daily loss (%) | −15.9 | −13.4 |
| total number of trades | 5237 | 3760 |
| number of gains | 2794 | 2060 |
| number of losses | 2443 | 1700 |
| number of no trades | 0 | 1477 |
| total net-profit/total losses | 0.070 | 0.203 |
| avg. net-profit/avg. loss | 0.070 | 0.203 |
| avg. net/std. deviation | 0.023 | 0.062 |
| 1% Value-at-Risk (%) | −4.0 | −3.8 |
| 5% Value-at-Risk (%) | −2.2 | −1.8 |

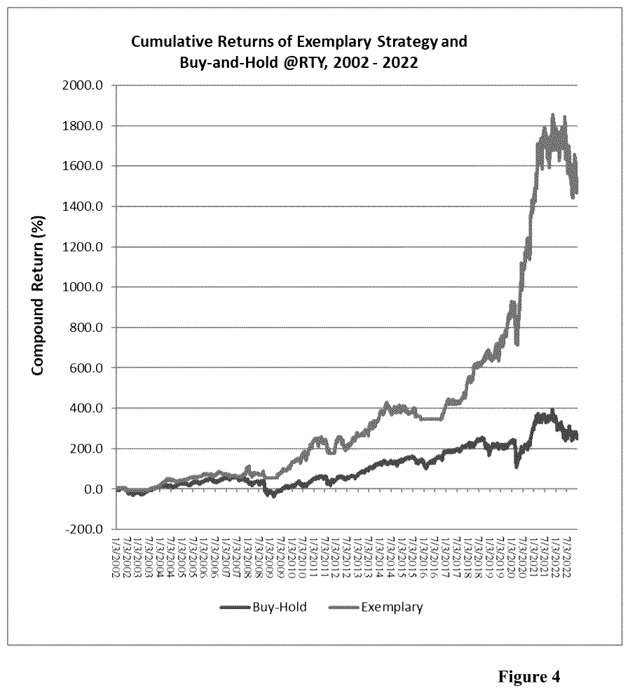

As shown in FIG. 4, the overall return achieved by the exemplary strategy substantially outperformed that of the benchmark Buy-and-Hold strategy over the past two decades from 2002 to 2022. The results achieved by the exemplary strategy on @RTY is unexpected and surprising, because the teachings of the prior art lead to a general expectation that all conventional investment strategies would not outperform a broad market, such as the Russell-2000 index.

It is posited that the ratio of probability-weighted net profit to probability-weighted loss can be utilized to extract indicative information of future performance from past results. For example, if the average-net-profit-to-average-loss ratio observed in the recent past is significantly greater than zero, it is expected that the exemplary strategy will statistically achieve positive net profit in near future. Alternatively, if the observed average-net-profit-to-average-loss ratio is significantly greater than that of the corresponding benchmark, it is expected that the exemplary strategy will outperform the benchmark statistically. The phrase “statistically achieve positive net profit” means that, after a sufficiently large number of trades, the total gains are expected to be significantly greater than the total losses. Therefore, probability-weighted ratio of net profit to loss determined from large number of past results can be used as an indicator of future performance.

In practice, prior average-net-profit-to-average-loss ratio observed in the recent past can be used for evaluating subsequent performance in near future. This is only valid if the observed data set is sufficiently large according to the principle of the large numbers in Probability and Statistics. To do so in this particular illustration, for each day, ratios of average net profit to average loss are calculated first by using the conventional moving average technique over the prior corresponding 5 years. For a specific time period, an average ratio can be then calculated over these prior 5 years ratios, and thus used for evaluating its subsequent performance.

TABLE 3
Subsequent Results of trading @RTY
by the Buy-and-Hold and exemplary strategy

| strategy | Buy-Hold | Exemplary | Buy-Hold | Exemplary |
|---|---|---|---|---|
| time period | 2017-2019 | | 2020-2022 | |
| total compound | 19.4 | 98.7 | 6.3 | 56.3 |
| return (%) | | | | |
| total daily gains (%) | 269.1 | 257.6 | 531.1 | 394.9 |
| total daily losses (%) | −248.2 | −186.4 | −510.3 | −338.7 |
| total net profit (%) | 21.0 | 71.2 | 20.8 | 56.2 |
| prior-5y-averaged total | 0.1399 | 0.1796 | 0.1216 | 0.2145 |
| net-Profit/Loss* | | | | |
| prior-5y-averaged avg. | 0.1399 | 0.1796 | 0.1216 | 0.2145 |
| net-Profit/Loss* | | | | |

*Average ratio of total net profit to total losses is calculated over prior 5-year ratios of total net profit to total losses in the specified period.
**Average ratio of average net profit to average loss is calculated over prior 5-year ratios of average net profit to average loss in the specified period.

As shown in Table 3, since its averaged prior 5-year ratio of average net profit to average loss is significantly (17.96% or 0.1796:1) greater than zero, the exemplary strategy resulted in a total compound return of 98.7% in the following three years, from 2017 to 2019. Similarly, as its averaged prior 5-year ratio of total net profit to total losses is significantly (21.45% or 0.2145:1) greater than zero, the exemplary strategy resulted in a return of 56.3% in the following three years, from 2020 to 2022. These results clearly demonstrate that a better prior ratio of probability-weighted net profit to probability-weighted loss indicates a better subsequent performance.

Furthermore, as its averaged prior 5-year ratio of average net profit to average loss is significantly (128.3%) greater than that of its benchmark Buy-and-Hold (0.1796:1 vs 0.1399:1), the exemplary strategy resulted in a compounded return that was more than five times as high (508.9%) as its benchmark (98.7% vs 19.4%) in the following three years, from 2017 to 2019. Similarly, as its averaged prior 5-year ratio of total net profit to total losses is significantly (176.4%) greater than that of its benchmark Buy-and-Hold (0.2145:1 vs 0.1216:1), the exemplary strategy resulted in a compounded return that was almost nine times higher (896.5% better) than its benchmark (56.3% vs 6.3%) in the following three years, from 2020 to 2022. Again, these results clearly demonstrate that a better prior ratio of probability-weighted net profit to probability-weighted loss indicates a better subsequent performance. The results also demonstrate that probability-weighted average-net-profit-to-average-loss ratio possesses capability to provide future performance insight from a large amount of historical performance data. In other words, the calculated probability-weighted ratios from the past results can be used as an indicator of future performance.

On the other hand, one may calculate a net-profit-to-loss ratio from the 21 annual rates of return. However, such an annual net-profit-to-loss ratio is not statistically significant or meaningful because a sample size of 21 is too small from a Probability and Statistics viewpoint. As a result, the annual net-profit-to-loss ratio cannot be used as an indication for future performance. For the same reasons, this also suggests the observed 21 annual rates of return contain no indicative performance information from a Probability and Statistics viewpoint.

### (d) Alternative Embodiment

Alternatively, the ratio of probability-weighted net profit to probability-weighted loss can also be estimated by the observed ratio between total net profit and total losses. This is because all individual daily gains reflect their frequencies that actually occurred according to their underlying probabilities. Similarly, all individual daily losses also reflect their frequencies that actually occurred according to their underlying probabilities. Total experienced net profit can be calculated by subtracting the total sum of experienced individual daily losses from the total sum of experienced individual daily gains. Therefore, the ratio of total net profit to total losses can be used to estimate the ratio of probability-weighted net profit to probability-weighted loss, and thus extract indicative performance information from the past results statistically when the number of daily rates of return becomes sufficiently large.

As shown in Table 2, the total net profits of the Buy-and-Hold strategy and the exemplary strategy are 192.2% and 311.7%, respectively. The total losses of the Buy-and-Hold strategy and the exemplary strategy are −2748.1% and −1532.9%, respectively. As a result, the estimated ratios of probability-weighted total net profit to probability-weighted total losses for the Buy-and-Hold benchmark and the exemplary strategy are 0.070:1 and 0.203:1, respectively.

For the exemplary strategy, one may comprehend its ratio of total net profit to total losses as that for every $0.203 gained, the investment made has to experience a loss of $1.00. In comparison, the benchmark Buy-and-Hold strategy achieved $0.070 by experiencing a $1.00 loss. In other words, for experiencing the same $1.00 loss, the exemplary strategy achieved about 2.9 times more profit than that of the Buy-and-Hold strategy. Therefore, the exemplary strategy is significantly more efficient than the benchmark Buy-and-Hold strategy in generating profit.

Regarding overall returns achieved, the exemplary strategy resulted in a total compound return of 1507.3%, which is 583.3% better than that of the benchmark Buy-and-Hold strategy at 258.4%. Similarly, the exemplary strategy also generated a superior profit compared to the benchmark Buy-and-Hold strategy in terms of value-added monthly index (VAMI) and average daily returns. Again, these results suggest that the exemplary strategy is significantly more efficient than the benchmark Buy-and-Hold strategy in generating profit.

On the other hand, the exemplary strategy resulted in total daily losses of −1532.9% which is substantially reduced to about 55.8% of the risk level of the benchmark Buy-and-Hold strategy at −2748.1%. Similarly, the exemplary strategy also resulted in substantially reduced risks compared with the benchmark Buy-and-Hold strategy in terms of worst peak-to-valley drawdown, maximum daily loss, and standard deviation over all daily returns. Therefore, the exemplary strategy is more effectively in reducing risks than the benchmark Buy-and-Hold strategy.

If its prior total-net-profit-to-total-losses ratio observed is significantly greater than zero, it is expected that the investment strategy will statistically achieve positive net profit with reduced risks. Similarly, if its prior total-net-profit-to-total-losses ratio observed is significantly greater than that of the benchmark, it is expected that the investment strategy will statistically outperform the benchmark.

Also, as shown in Table 3, the averaged prior 5-year ratio of total net profit to total losses for the exemplary strategy is significantly greater than zero (17.96% or 0.1796:1). This resulted in a 98.7% return in the next three years, from 2017 to 2019. Similarly, with an averaged prior 5-year ratio of total net profit to total losses of 21.45% or 0.2145:1, the exemplary strategy resulted in a 56.3% return in the following three years, from 2020 to 2022. Therefore, these results clearly demonstrate that a better prior ratio of probability-weighted net profit to probability-weighted loss indicates a better subsequent performance.

Furthermore, the averaged prior 5-year ratio of total net profit to total losses for the exemplary strategy is significantly (128.3%) greater than that of its benchmark Buy-and-Hold strategy (0.1796:1 vs 0.1399:1). This resulted in a compounded return that was 508.9% better than its benchmark (98.7% vs 19.4%) in the next three years, from 2017 to 2019. Similarly, with an averaged prior 5-year ratio of total net profit to total losses that is significantly (176.4%) greater than that of its benchmark Buy-and-Hold strategy (0.2145:1 vs 0.1216), the exemplary strategy resulted in a compounded return that was 896.5% better than its benchmark (56.3% vs 6.3%) in the following three years, from 2020 to 2022. Again, these results clearly demonstrate that a better prior ratio of probability-weighted net profit to probability-weighted loss indicates a better subsequent performance.

These results also demonstrate its prognostic ability to provide future performance insight from a large amount of historical performance data. Therefore, the calculated probability-weighted ratios from the past results can be used as an indication for future performance evaluation.

### CONCLUSION, RAMIFICATIONS, AND SCOPE OF INVENTION

The disclosed method provides a novel technique to extract statistically-informed indicative information from historical investment performance. The technique is based on the mathematical concept of probability-weighted net-profit/loss ratio. The method provides a new, practical, useful, and specific application of mathematical calculation of probability-weighted net-profit/loss ratio. This extracted indication enables more effective performance evaluation and guiding for an investment strategy for optimization and implementation. Specifically, probability-weighted net-profit/loss ratios are calculated from past at least daily returns. The calculated ratios observed over the recent past can be used as an indication if positive net profit or outperforming a benchmark can be statistically achieved in near future. A higher ratio of probability-weighted net profits to losses in the recent past suggests greater likelihood of strong future performance.

In contrast, the teachings of the prior art lead to a general expectation that past performance is not indicative of future results. Existing techniques are only useful for evaluating past performance because they cannot provide nor extract any information that may be indicative of future or subsequent performance from past performance observed.

The invention involves a specific application of mathematical calculations of probability-weighted ratios.

Its crucial ability to extract indication of future performance previously unattainable is a useful, practical and technological solution to the long-standing challenge that past results are not necessarily indicative. The ability to transform historical performance into new prognostic information provides a useful advancement with concrete utility in the field of quantitative finance. The future performance indication demonstrates the method is significantly more than mathematical calculations using a computer.

The present method leverages mathematical calculations of probability-weighted net-profit/loss ratios to enable future performance indication—providing significant practical utility beyond mathematical computations. The capability to extract previously inaccessible insights into future potential demonstrates a technological improvement over conventional techniques for evaluating past investment performance.

Specifically, the ability to transform historical data into new forward-looking prognostic information addresses the longstanding challenge that past results alone is not necessarily indicative of future performance. By going beyond abstract ideas to unlock previously impossible future insights, the invention provides a useful, real-world solution for guiding investment strategy optimization.

The technique serves as a practical and useful tool for extracting new indicative signals from existing information, where conventional approaches yield limited value. Overall, the capacity to indicate likely future performance represents a technical advancement with practical applicability for quantitatively informing investment decisions based on historical data analysis.

In summary, the invention delivers a specific, practical, and useful application for extracting statistically-based forward-looking investment performance information from historical data. This provides significant technical improvements, going beyond mathematical calculations to address the problem that past results alone offer limited guidance for future decisions. The future performance indication represents a meaningful contribution over conventional approaches.

While the embodiments have been described with a certain degree of particularity, it should be understood as the present disclosure is made by way of illustration and that numerous changes in the details of operational procedures may be implemented without departing from the spirit and scope of the invention.

Although the embodiments have been illustrated with the particular futures contract on Russell-2000 (@RTY), it can also be implemented with other securities or investment assets without departing from the spirit and scope of the invention.

Although the embodiments have been illustrated with daily returns, other time scales may be implemented without departing from the spirit and scope of the invention, such as by hour, minute, seconds or even milliseconds, so long as the total number of trades is sufficiently large.

The detailed description above is example but not restrictive of the invention as claimed. The drawings, together with the detailed descriptions, may illustrate a few embodiments that explain the general principles of the present invention and to teach those skilled in the field how to employ it. The scope of the invention should be determined by the claims and their legal equivalents, rather than by the given examples.

We claim:

1. A computer implemented method for extracting future indication from past investment results of a specified security traded by a specified investment strategy,
the method comprising:
a) specifying an investment strategy, a benchmark strategy in order to obtain a predetermined benchmark, and a security to be traded;
b) organizing, by a computer-based system, by dividing and/or combining, the original trading results of said investment strategy and said benchmark strategy;
c) determining, by a computer-based system, past performance from said large data set for both said investment strategy and said benchmark strategy, including all individual gains and all individual losses, average gain and average loss, and average net profit;
d) calculating, by a computer-based system, probability-weighted average-net-profit-to-average-loss ratio by calculating ratio of average net profit to average loss for both said investment strategy and said benchmark strategy, and thereby obtaining an investment strategy ratio and a benchmark ratio, respectively;
e) using said calculated ratio of said investment strategy from the past results as an indication of corresponding future performance; and
f) accepting said investment strategy if said average-net-profit-to-average-loss ratio of said investment strategy is greater than said benchmark ratio,
whereby said investment strategy which has been accepted will statistically outperform said benchmark.

2. The method of claim 1, further comprising:
g) accepting said investment strategy if said average-net-profit-to-average-loss ratio of said investment strategy is greater than zero;
whereby said investment strategy which has been accepted will generate positive net profit statistically.

3. A computer implemented method for extracting future indication from past investment results of a specified security traded by a specified investment strategy,
the method comprising:
a) specifying an investment strategy, a benchmark strategy in order to obtain a predetermined benchmark, and a security to be traded;
b) organizing, by a computer-based system, by dividing and/or combining, the original trading results of said investment strategy and said benchmark strategy;
c) determining, by a computer-based system, past performance from said large data set for both said investment strategy and said benchmark strategy, including all individual gains and all individual losses, total gains and total losses, and total net profit;
d) calculating, by a computer-based system, probability-weighted total-net-profit-to-total-losses ratio by calculating ratio of total net profit to total losses for both said investment strategy and said benchmark strategy, and thereby obtaining an investment strategy ratio and a benchmark ratio, respectively;
e) using said calculated ratio of said investment strategy from the past results as an indication of corresponding future performance; and
f) accepting said investment strategy if said total-net-profit-to-total-losses ratio of said investment strategy is greater than said benchmark ratio,
whereby said investment strategy which has been accepted will statistically outperform said benchmark.

4. The method of claim 3, further comprising:
g) accepting said investment strategy if said total-net-profit-to-total-losses ratio of said investment strategy is greater than zero,
whereby said investment strategy which has been accepted will generate positive net profit statistically.

5. A machine comprising one or a plurality of computers for extracting future indication from past investment results of a specified security traded by a specified investment strategy,
the machine comprising:
a) specifying means for specifying an investment strategy, a benchmark strategy in order to obtain a predetermined benchmark, and a security to be traded;
b) organizing means for organizing, by dividing and/or combining, the original trading results of said investment strategy and said benchmark strategy;
c) computing means for computing past performance from said large data set for both said investment strategy and said benchmark strategy, including all individual gains and all individual losses, total gains and total losses, average gain and average loss, total net profit and average net profit;
d) calculating means for calculating probability-weighted average-net-profit-to-average-loss ratio by calculating ratio of average net profit to average loss for both said investment strategy and said benchmark strategy, and thereby obtaining an investment strategy ratio and a benchmark ratio, respectively;
e) determining means for using said calculated ratio of said investment strategy from the past results as an indication of corresponding future performance; and
f) evaluating means for said investment strategy if said average-net-profit-to-average-loss ratio of said investment strategy is greater than said benchmark ratio,
whereby said investment strategy which has been accepted will statistically outperform said benchmark.

6. The machine of claim 5, further comprising:
g) second calculating means for calculating probability-weighted total-net-profit-to-total-loss ratio by calculating ratio of total net profit to total losses for both said investment strategy and said benchmark strategy, and thereby obtaining an investment strategy ratio and a benchmark ratio, respectively;
h) second determining means for using said calculated total-net-profit-to-total-loss ratio of said investment strategy from the past results as an indication of corresponding future performance; and
i) second evaluating means for accepting said investment strategy if said total-net-profit-to-total-loss ratio of said investment strategy is greater than said benchmark ratio,
whereby said investment strategy which has been accepted will statistically outperform said benchmark.

7. The machine of claim 5, further comprising:
j) third calculating means for calculating probability-weighted total-net-profit-to-total-loss ratio by calculating ratio of total net profit to total losses for both said investment strategy and said benchmark strategy, and thereby obtaining an investment strategy ratio and a benchmark ratio, respectively;
k) third determining means for using said calculated total-net-profit-to-total-loss ratio of said investment strategy from the past results as an indication of corresponding future performance; and
l) third evaluating means for accepting said investment strategy if said total-net-profit-to-total-loss ratio of said investment strategy is greater than zero,
whereby said investment strategy which has been accepted will statistically achieve a positive net profit.

8. The machine of claim 5, further comprising:
m) forth evaluating means for accepting said investment strategy if said average-net-profit-to-average-loss ratio of said investment strategy is greater than zero,
whereby said investment strategy which has been accepted will statistically achieve a positive net profit.
